(19) United States
(12) Patent Application Publication
(10) Pub. No.: US 2014/0319104 A1
(43) Pub. Date: Oct. 30, 2014

(54) ELECTRICAL INSULATING ELEMENT MADE OF CERAMIC MATERIAL FOR AN ELECTRICAL PROCESSING DEVICE, CORRESPONDING PROCESSING DEVICE

(71) Applicant: MIYACHI EUROPE GMBH, Purchheim (DE)

(72) Inventor: Dieter Kemmerer-Fleckenstein, Moosburg (DE)

(21) Appl. No.: 14/357,086

(22) PCT Filed: Nov. 8, 2012
(86) PCT No.: PCT/EP2012/072164

§ 371 Date: May 8, 2014

(30) Foreign Application Priority Data
Nov. 9, 2011 (DE) 20 2011 051 908.2
Nov. 9, 2011 (DE) 20 2011 051 909.0
Nov. 9, 2011 (DE) 20 2011 051 910.4

(51) Int. Cl. B23K 11/31; B23K 3/047

(52) U.S. Cl. CPC B23K 11/31; B23K 3/047
USPC 219/85.14; 219/78.01

(57) ABSTRACT

An electrical welding or soldering device (1), including an electrode (2, 3), to which electric current and a pressing force are applied, and including an electrode retainer (5, 6) that transmits the pressing force. An electrical insulating element (13) is arranged between the electrode retainer (5, 6) and the electrode (2, 3). The electrical insulating element is designed as a pressure-resistant and dimensionally stable insulating disk made of a ceramic material. The insulating disk (13) has a contour that can transmit force and is not rotationally symmetric.

### CROSS REFERENCE TO RELATED APPLICATIONS

This application is a United States National Phase Application of International Application PCT/EP2012/072164 and claims the benefit of priority under 35 U.S.C. §119 of German Utility Model Applications DE 20 2011 051 908.2 filed, Nov. 9, 2011, DE 20 2011 051 909.0 filed, Nov. 9, 2011, and DE 20 2011 051 910.4 filed Nov. 9, 2011, the entire contents of which are incorporated herein by reference.

### FIELD OF THE INVENTION

The present invention pertains to an electrical processing device, in particular welding or soldering device with an electrode tool, to which electric current and pressing pressure are applied, and with an electrode tool holder, transmitting the pressing pressure, as well as with an electrical insulating element between the tool holder and the tool, and also pertains to an electrical insulating element for an electrical processing device.

### BACKGROUND OF THE INVENTION

In electrical resistance-pressure welding devices, it is known to electrically insulate the electrode holders or apply an insulating plastic film between the welding tool and the guiding system. These insulating measures are technically complex in one variant and not sufficiently reliable in the other.

### SUMMARY OF THE INVENTION

An object of the present invention is to show a better possibility for insulating tools, in particular electrodes, to which current is applied.

The insulating disk according to the invention has the advantage that it is pressure-resistant and dimensionally stable due to its ceramic material. Due to its maximum stiffness and shear strength, it can transmit forces and at the same time insulate electrically and thermally, whereby the forces are transmitted without process-relevant deformation. In particular, feeding and pressing forces can be transmitted via the insulating disk without any undesired flexibilities. The forces initiated by a feeding device can be transmitted to the tool, in particular an electrode in a controlled and loss-free manner. In this case, the force acting on a workpiece in the processing device can be adjusted and controlled and possibly regulated with high process reliability.

A contour of the insulating disk capable of transmitting force andor torque is particularly favorable. On the one hand, an exact positioning of the tool, in particular of an electrode, against the respective tool or electrode holder can take place via this contour. On the other hand, also possibly torques and movements can be transmitted, if, e.g., the tool, in particular an electrode, is rotated about its main axis, which, e.g., can take place in relation to the workpiece. Any initiated rotational movements and torques, but also possibly lateral forces are reliably transmitted and supported by the insulating disk over the contour.

A force- and torque-transmitting contour can be designed in different ways and be present at one or more points of the insulating disk. In particular, it may interact with a corresponding countercontour on the tool, in particular an electrode, and tool holder, e.g., an electrode holder. A complementary addition of contours on both sides is advantageous for the reliable and backlash-free transmission of movements, forces and torques.

Complementary contours on the insulating disk, tool and tool holder are also advantageous for identification, assignment and safety purposes. Erroneous combinations may also be ruled out. The contour design may create a defined and insulating interface between the tool and the tool holder.

The insulating element may space the tool and tool holder apart from one another in the mounting position and create a gap. A ring-like seal may advantageously be arranged here to further secure the electrical insulation and make it insensitive to environmental influences and prevent shunts. In addition, it may be compressible and possibly absorb manufacturing and gap tolerances.

The processing device may be designed in different ways. There are particular advantages in an electrical resistance-pressure welding device or an electrical soldering device, both of which work with electrodes, which can be pressed against a workpiece and which are electrically insulated by means of the ceramic insulating disk against its respective electrode holder and are connected with the counterholder in a pressure-resistant manner. Such an insulation may be present on one or more or all electrodes.

Such welding or soldering devices with one or more insulating disks may in turn be designed in different ways. A modular design, which makes possible a modular system and consequently a very broad range of application, is particularly favorable.

In particular, the feeding device with its components may have a modular construction, and various drive modules are available for different process conditions and force ranges. The client can convert and add to the processing device thanks to its modularity, if necessary, and thus adapt to changed use conditions, e.g., different workpieces, if necessary. The modular design makes a modular system possible and consequently offers a very broad range of application as well as simple, fast and cost-effective retrofit and conversion possibilities.

The feeding device has a guiding means, which is connected between the drive or the drive module and a tool holder, in particular an electrode holder. The guiding means can be retained in the various modular embodiments of the processing device and in particular in the case of a replacement of the drive modules. For this, it may have a uniform design for the different force ranges and possibly also displacement ranges. A defined interface makes possible the replacement and changing of drive modules, which can be attached to and mounted on the guiding means, whereby this means can in turn be mounted on a fixed or movable support.

The interface can have uniform ports for the frames or basic bodies of the guiding means and drive modules. Furthermore, the guiding means can have a drive element, in particular a drive rod, which is movably guided and mounted, for the transmission of force and displacement, which drive element has a uniform port for the direct or indirect connection with a driven element of the drive module. In case of an indirect connection, a coupling can be inserted.

For the effective and precise transmission of force and displacement, a design of the drive element as an axially movable drive rod, which can be designed correspondingly to cover the entire force and displacement range, is advantageous. A means for securing against rotation makes possible a defined pure axial movement and allows an exact and torsion-free feeding of the workpiece, in particular an electrode. In particular, lateral forces or torques, which are initiated at the process point on the tool, in particular the electrode, can be absorbed and supported by the feeding device. The support can take place on the guiding means, whereby the drive module is relieved hereby and can be correspondingly disconnected in a simpler manner.

The drives or drive modules can be designed in any suitable manner, for example, as a pneumatic or hydraulic cylinder or as a servo drive. A cylinder may apply, e.g., a defined force and transmit it to the electrode via the insulating disk. With a servo drive, besides force, the displacement can also be controlled or possibly regulated. A servo drive can, e.g., be designed as an electrical spindle drive, a rack-and-pinion drive or the like and comprise corresponding measuring systems for displacement and force or torque. The pressure-resistant design of the insulating disk is particularly advantageous for the exact controllability or regulatability.

Further modules of the processing device may be, in particular, a common support for the feeding device besides a counter-tool holder, an adjusting device for a movable support and the one or more tool holders, in particular electrode holder. The tools, in particular electrodes, can also be replaced. The insulating disk can be used universally and for all variants.

The claimed electrical processing device can also be used in automated manufacturing plants. The adjusting device, which can provide for a defined prepositioning or feeding of a support, which is movable and is designed, e.g., as a carriage, against a workpiece feed, is favorable for this. This is favorable for optimized and constant process conditions as well as for a high joining quality. The feeding device and the tools, in particular electrodes, can be floated during the feeding and pressing on the workpiece and consequently compensate for its tolerances with regard to location and shape, etc.

A prepositioning and temporary location lock by means of the adjusting device is also favorable for the use of the processing device, e.g., of an electrical or nonelectrical joining device, in automated manufacturing plants. Workpieces may be transported transversely to the process axis and through the free space between the, e.g., tong-like closing tools, in particular electrodes. Also, thanks to the defined positioning possibility, this tong-like opening and the feed path of the tools, in particular electrodes, during the closing and pressing on the tool can be reduced. This allows an optimized design of the feeding device. The pressure-resistant and dimensionally stable insulating disk also has an advantageous effect here.

Moreover, for optimization, a multipart and telescopic design of the adjusting device and its two or more adjusting parts is advantageous. This allows a coarse adjustment and a fine adjustment and is also favorable for the above-mentioned prepositioning with possibility of detaching and floating as well as for an exact presetting and adaptation of the adjusting device. Even greater feeding paths of the tools, in particular electrodes, between a retraction or resting position and a working position can be achieved with the adjusting device.

A sensor mechanism array at the guiding means that may be uniform for all modular configurations or modular assemblies is also favorable.

Furthermore, the processing device with its components, in particular also the adjusting device, may have a uniform operating and service side, which guarantees an optimal access, and in particular for setting and maintenance purposes, especially also to the ceramic insulating disk and its fastening. In the guiding means, the means for securing against rotation lies on this said side, whereby from here as well, an access to the drive element and its mounting is given. At the guiding means, these parts may lie open towards the said side, whereby a possibly common covering for the feeding device can close the access in a reliable manner. Also in case of the drives or drive modules, the operating and adjusting elements may lie on the said operating and service side. In case of the adjusting device, the actuating drive or actuating drives, besides the carrier, stop as well as possibly shock absorbers and their adjusting possibilities can be reached comfortably. The operation and maintenance is simplified and can always remain the same within the modular system, which markedly reduces documentation and training costs.

The present invention is shown by way of example and schematically in the drawings. The various features of novelty which characterize the invention are pointed out with particularity in the claims annexed to and forming a part of this disclosure. For a better understanding of the invention, its operating advantages and specific objects attained by its uses, reference is made to the accompanying drawings and descriptive matter in which preferred embodiments of the invention are illustrated.

### BRIEF DESCRIPTION OF THE DRAWINGS

In the drawings:

FIG. 1 is a modular electrical processing device with ceramic insulating disk in perspective view;

FIG. 2 is a frame with a carriage of the processing device in perspective view;

FIG. 3 is a guiding means of a feeding device in perspective view;

FIG. 4 is a perspective view of a drive module design;

FIG. 5 is a perspective view of another drive module design;

FIG. 6 is a perspective schematic diagram of a ceramic insulating disk in its association with tool holders;

FIG. 7 is a top view of the ceramic insulating disk;

FIG. 8 is a cross section through the insulating disk according to intersecting line VIII-VIII of FIG. 7;

FIG. 9 is a perspective view of a seal;

FIG. 10 is a perspective view of an element holder for the insulating disk from one of different angles of view;

FIG. 11 is a perspective view of an element holder for the insulating disk from another of different angles of view;

FIG. 12 is a section through the guiding means and an element holder with ceramic insulating disk;

FIG. 13 is a perspective view of the feeding device with a movable support and an adjusting device;

FIG. 14 is a front view of the adjusting device; and

FIG. 15 is a section through the adjusting device according to intersecting line XV-XV of FIG. 14.

### DESCRIPTION OF THE PREFERRED EMBODIMENTS

Referring to the drawings in particular, the present invention pertains to an electrical processing device (1) with an insulating disk (13) as well as the insulating disk (13) itself.

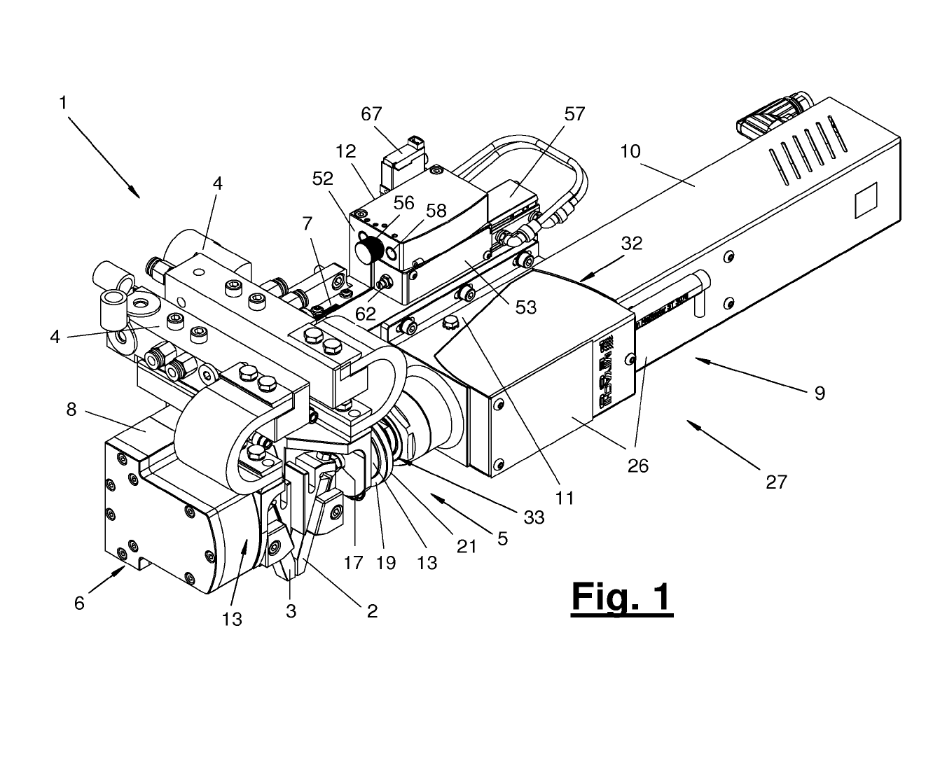

FIG. 1 shows, in perspective view and by way of example, such an electrical processing device (1), which is designed here as a modular electrical resistance-pressure welding device. The present invention basically pertains to electrical processing devices (1), which have a tool (2, 3), to which electric current and pressing pressure are applied, as well as with which a tool holder (5, 6) is connected. An electrical insulating element (13) is arranged between the tool holder (5, 6) and the tool (2, 3). The processing device (1) may have one or more of the said tools (2, 3). These may be designed in different ways.

In the exemplary embodiment shown the tools (2, 3) are designed as electrodes and are present, e.g., in pairs. As an alternative, the number of the tools (2, 3) and tool holders (5, 6) may also be greater than two. In a further variant, a processing device may only have one current-supplied tool (2) and one tool holder (5). The electrical processing device (1) shown in FIG. 1 can also be used for soldering and for other electrothermal joining processes with application of current and pressure to a tool.

The electrical processing device (1) shown in FIG. 1 has the said two electrodes (2, 3) and related electrode holders (5, 6), whereby the electrodes (2, 3) carry each a power connector (4), which is electrically insulated and arranged separately from the electrode holder (5, 6). The electrodes (2, 3) can be connected hereby directly by line to an external power source.

The electrodes consist, e.g., of an electrically conductive metal and have a shape adapted to the respective process and to the workpiece. They may have a multipart design and have a basic part, which can be connected with the electrode holder (5, 6) and, e.g., is bent, on which changeable jaws are, if necessary, mounted for the workpiece contact.

The electrical processing device (1) shown in FIG. 1 has the said feeding device (9), which adjusts the electrodes (2, 3) in relation to one another and applies the pressing pressure. The feeding device (9) consists of a drive (10) and a guiding means (11) for transmitting drive to the electrode (2). In the embodiment shown, the feeding device (9) has only one drive (10), whereby the guiding means (11) on the drive side is connected with a tool holder (5) and feeds and presses this together with the attached electrode (2) onto a workpiece (not shown). In the embodiment shown the counterelectrode (3) is arranged with its electrode holder (6) relatively fixed opposite the fed electrode (2). The feeding device (9) and tool holder (6) relatively fixed thereto are located on a common support (8). This support may be designed as a rigid and fixed holder. In the embodiment shown, the common support (8) is designed as a carriage, which is movably mounted on a frame (7).

In the embodiment shown the common support (8) has an axis of motion, which is aligned parallel to the drive and feed axis (48) and can travel along this axis of motion. As an alternative, it may also have more than one axis of motion. Further, in the embodiment of FIG. 1, an adjusting device (12) is arranged between the support (8) and the frame (7). This adjusting device may have one or more adjusting functions. It can preposition, e.g., the support (8) by means of an adjusting part (53) with controllable actuating drive (57) in a stop position, e.g., at the guide end of the frame (7). This may be a defined entering position for the feeding of a workpiece, whereby the adjusting device (12) then releases the support (8) again, so that it can float upon actuation of the feeding device (9) at the workpiece. Such an embodiment is advantageous for automated production lines.

The adjusting device (12) may have a one-part or multipart design and may have one, two or more adjusting parts (52, 53) with housings (54, 55) and actuating drives (56, 57). It may, in particular, provide for an additional adjusting path of the support (8) opposite the frame (7). The actuating drive (56) may be brought about by means of a motor drive means, a cylinder or the like or by means of a manual adjusting device, e.g., a screw.

The processing device (1) has a modular design. In particular, the drive (10) and the guiding means (11) of the feeding device (9) may be designed as modules, which may possibly be replaced.

The support (8) also represents a module. It may selectively either be fixed or arranged movably in a carriage-type design on the frame (7). If necessary, the adjusting device (12), which also represents a module, can be attached to the supportframe. Due to the modular structure, the processing device (1) represents a modular system, which makes possible different configurations and a replacement of the modules or components as well.

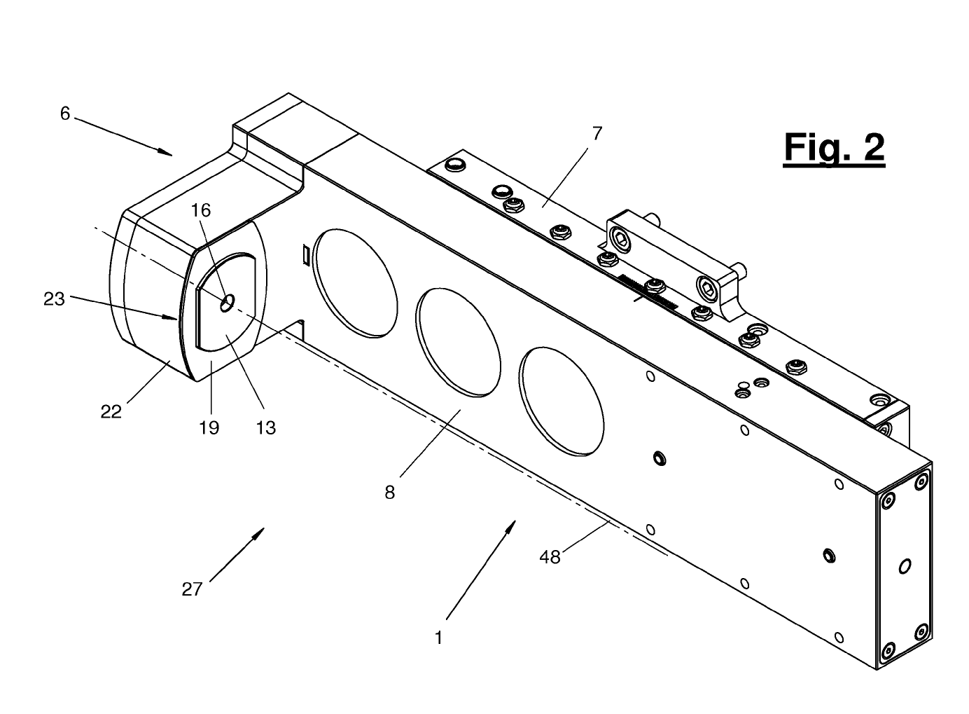

FIG. 2 shows the common support (8) in the attaching position on the frame (7), whereby also the port on the frame (7) for the adjusting device (12) (not shown here) can be seen.

The support (8) has, e.g., an L shape and offers preparatory connection and attachment possibilities for the feeding device (9) on the side opposite the frame (7) and its guide.

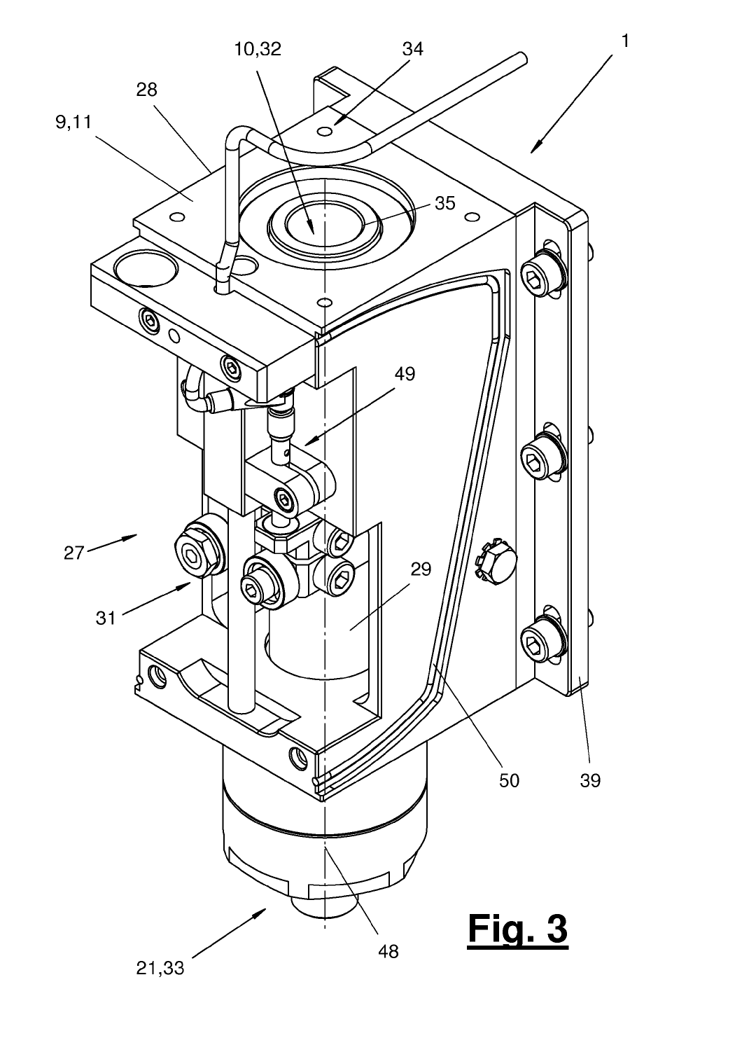

FIGS. 3 through 5 show the drive (10) and the guiding means (11) of the feeding device (9). These parts are hidden in FIG. 1 behind a possibly common cover (26). The cover (26) is arranged on the side opposite the common support (8) and the frame (7). This may also be a common operating and service side (27), from which the components of the processing device (1) are accessible for maintenance and mounting purposes.

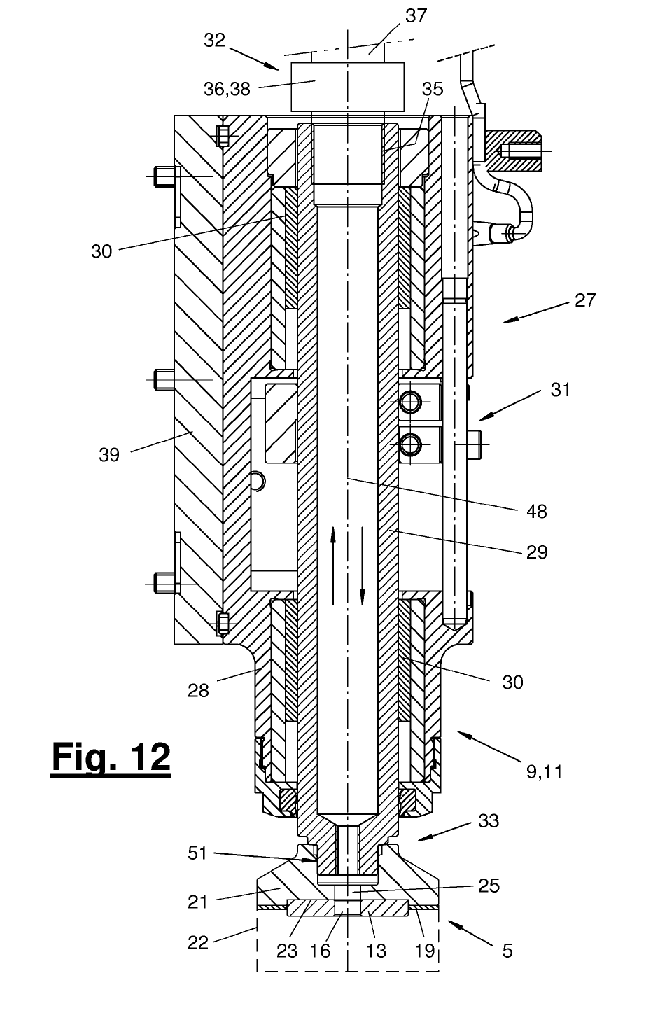

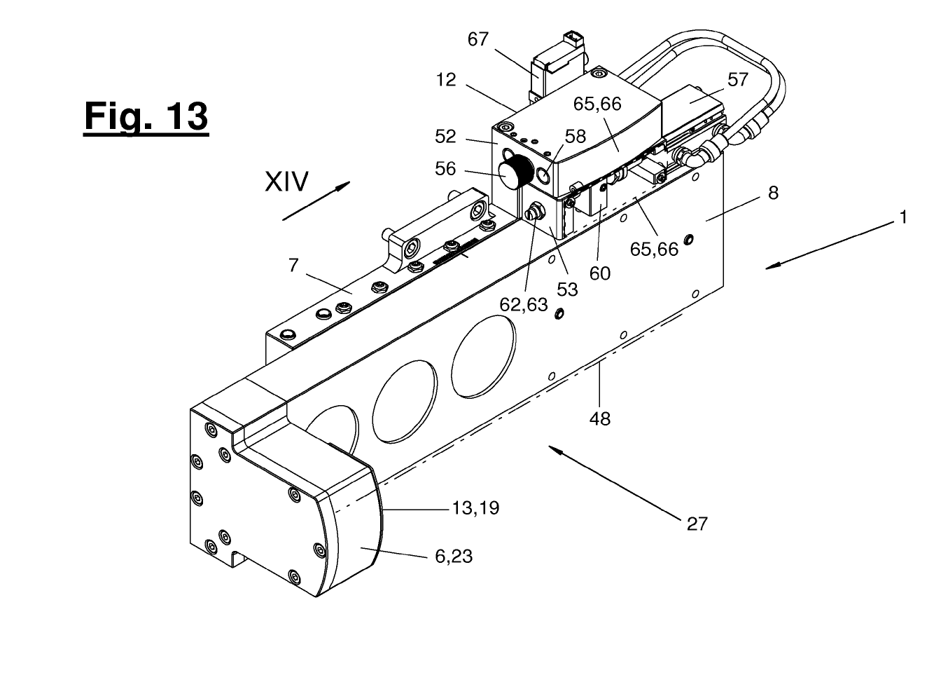

FIGS. 3 and 12 show the guiding means (11), which is fastened with its frame or basic body (28) to the support (8) directly or with an attaching flange (39). The guiding means (11) comprises a longitudinally movable drive element (29), e.g., a drive rod, with a corresponding mount (30) and also a means for securing against rotation (31) situated on the operating and service side (27). The drive element (29) can be connected at the upper end with the drive (10) and its driven element and can be coupled at the lower end with the element holder (21) indicated by an arrow. Defined interfaces (32, 33) are provided for the changeable attachment of drives (10) and of the tool holder (5) to the guiding means (11).

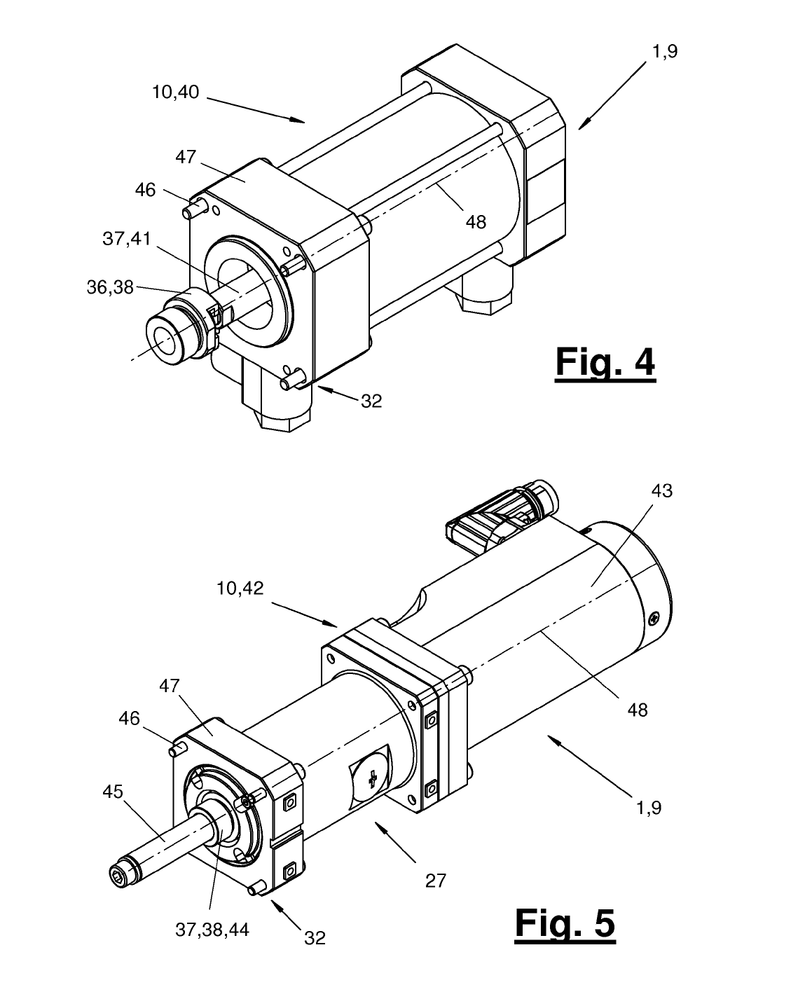

FIGS. 4 and 5 show two variants of the modular drive (10). FIG. 4 shows a design variant as a fluidic, in particular pneumatic or hydraulic drive (40) with a cylinder.

Within the framework of a module and modular system, e.g., this fluid drive (40) may be designed differently and in particular generate different forces. The driven element (37) is formed here by a piston rod (41).

FIG. 5 shows a drive variant with a servo drive (42) which has, e.g., a controllable and regulatable motor (43), in particular an electric motor and possibly a gear mechanism as well as an output drive, e.g., a spindle drive. This spindle drive may have, e.g., a spindle nut (44), which can travel in the feed direction or in the direction of the process axis (48) and which forms the driven element (37) and which is pushed out and pulled in by a threaded spindle (45) driven in a rotating manner on the motor side. The driven element (37) of the modular drive (10) is connected in a suitable manner directly or indirectly via a coupling (36) with the drive element (29) of the guiding means (11).

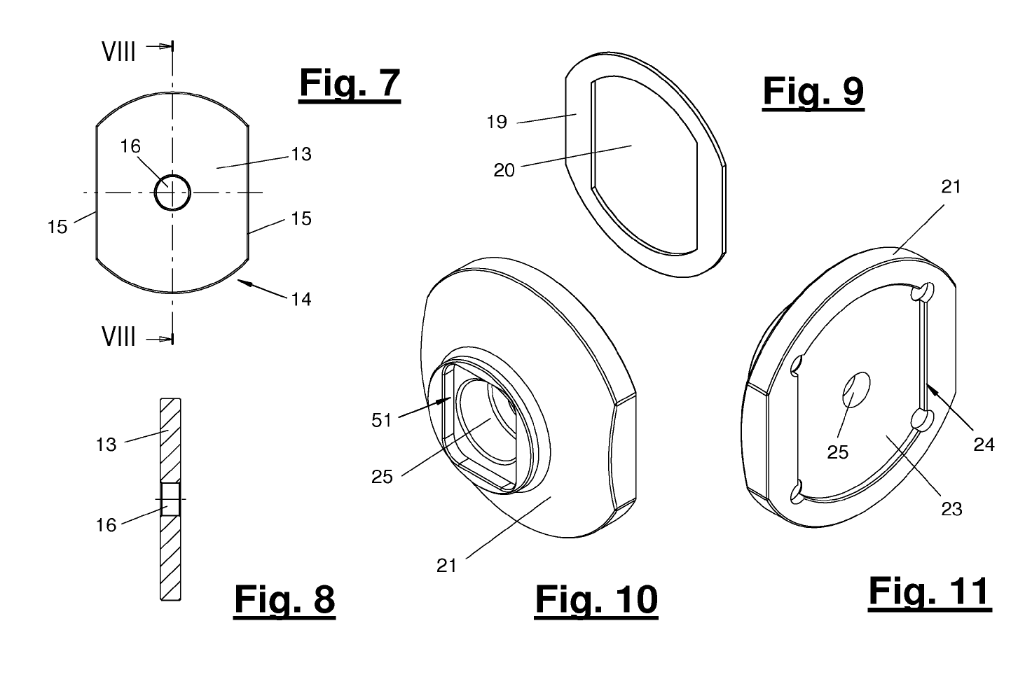

FIGS. 7 and 8 show the electrical insulating element (13) in a top view and in a sectional view. The electrical insulating element (13) is designed as a pressure-resistant and dimensionally stable insulating disk, which consists of a ceramic material. This may be an oxide ceramic, in particular aluminum oxide, zirconium oxide, titanium oxide or zirconium-reinforced aluminum oxide or the like.

The insulating disk (13) has a contour (14) that is not rotationally symmetrical (14). This contour is able to transmit forces, torques and possibly movements. In particular, it can define a location and orientation. In the exemplary embodiment shown, this contour (14) is formed on the circumference of the, e.g., flat insulating disk (13). The not-rotationally-symmetrical contour (14) can be formed, e.g., by two or more parallel, lateral flat surfaces (15) on the disk body. The disk body may have a rotationally symmetrical shape on the other circumferential areas. FIG. 7 shows this design. As an alternative, the contour (14) on the circumference can be designed as prismatic or in a different way with local projections or the like. In these design variants, the insulating disk (13) may have planar top and bottom sides. Further, it may have a central passage opening (16) for a fixing element (17), e.g., a screw.

In another, not shown embodiment, the contour (14), which is not rotationally symmetrical and is, e.g., capable of transmitting force, can be designed in a different way and at a different location, e.g., by means of a profiling on the top side andor the bottom side of the insulating disk (13). This contour may be present as an alternative or in addition to the above-described contour (14) on the circumference and is also not rotationally symmetrical to the central axis or passage opening (16).

The respective tool holder (5, 6) has a receiver (23) for the insulating element (13). Likewise, the respective tool (2, 3) also has such a receiver (23). The receivers (23) are designed, e.g., as a trough-like, recessed and positive-locking socket for the disk-shaped insulating element (13) and receives this in the mounting position between them. As an alternative, the association may be reversed, whereby the insulating disk (13) has recesses on one or both sides and corresponding projections are present on the tool (2, 3) andor tool holder (5, 6).

The respective receiver (23) has a contour (24) for the disk meshing, which contour is designed as a counter-contour to the contour (14) of the insulating disk (13) and meshes with same in a positive-locking and preferably backlash-free manner. This makes possible an exact mutual positioning of the tool holder (5, 6) and the tool (2, 3) as well as, if necessary, a transmission of movements, forces and torques as well. Preferably, the contours (14, 24) are complementary to one another.

In the exemplary embodiment shown, the sockets (23) also have just flat surfaces, between which the flat surfaces (15) of the insulating disk (13) are accommodated in a precisely fitting manner. Also, the circumferential areas of the socket (23) and of the insulating disk (13) are aligned with one another in a precisely fitting manner. For avoiding jammings at junction areas of a contour (14, 24), a recess can be present in each case, so that interrupted edge areas are hereby formed.

In the embodiment shown, the receivers or sockets (23) have planar bottoms, against which the top side and bottom side of the insulating disk (13) rest flatly. When, in a modified embodiment, a not-rotationally symmetrical contour is designed by means of a profiling on the top side or bottom side of the insulating disk (13), a corresponding countercontour, which meshes with the said profiling in a positive-locking and preferably backlash-free manner and hereby is preferably complementary as well, is located on the bottom of the receiver or socket (23).

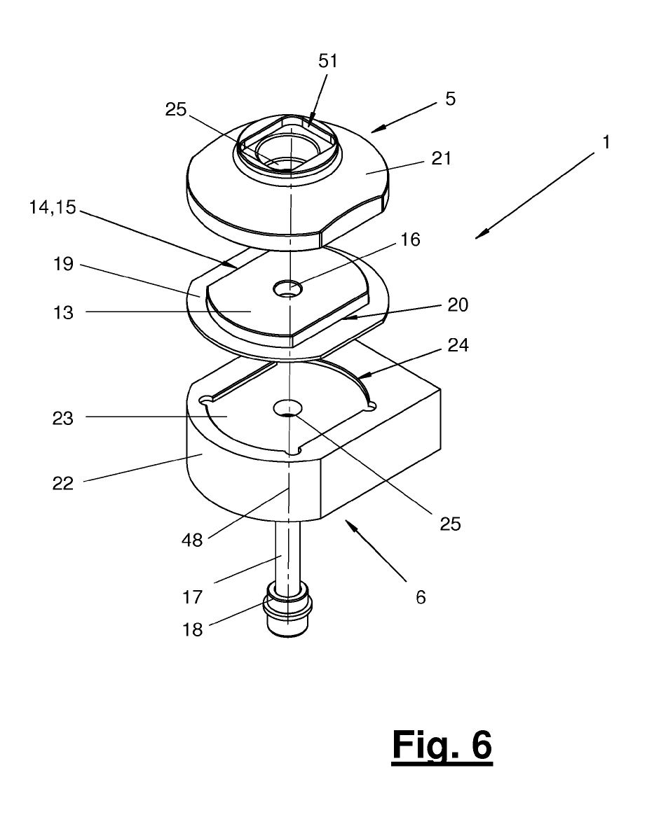

FIG. 1 shows the complete electrode array with two electrodes (2, 3) and two electrode holders (5, 6), whereby only one insulating disk (13) can be seen on the movable electrode holder (5). FIG. 6 illustrates in a schematic diagram the mutual association of an insulating disk (13) and a respective receiver (23) on an electrode holder (5, 6). The electrodes (2, 3) are not shown here for the sake of clarity, whereby also only one of the two insulating disks (13) is shown for the same reason.

In addition, the association of a fixing element (17) with the relatively stationary tool or electrode holder (6), which is arranged, e.g., on a transversely projecting attachment at one end of the common support (18), can be recognized in FIG. 6. This attachment forms an element holder (22) with the receiver (23) and with a threaded hole or the like for the fixing element (17). The receivers (23) of the element holders (21, 22) and of the tools or electrodes (2, 3) have each a preferably central passage opening (25), which is aligned with the passage opening (16) of the associated insulating disk (13) in the mounting position. Compared to the fixing element (17), the passage openings (16, 25) have excess for avoiding current-conducting contacts. The contact-free centering of the shank of the screw (17) can be brought about by means of the insulating means (18), which is mounted at the head end of the screw shank and with which the screw (17) is supported on the tool (2, 3), e.g., on its base part, via a ring-shaped countersinking there and at the same time centers the screw shank in the openings (16, 25) in a contact-free manner. The axial forces initiated during the feeding of the electrodes are transmitted and supported via the pressure-resistant insulating disk (13), whereby the fixing element (17) can have only a holding function and the mutual positioning of the tool (2, 3) and the tool holder (5, 6) is achieved via the contours (14, 24) in the above-mentioned manner.

The receivers (23) of the electrode (2, 3) and related electrode holder (5, 6) have a depth which is lower than the thickness of the insulating disk (13). In the mounting position, the insulating disk (13) spaces the electrode (2, 3) and the related electrode support (5, 6) apart while forming a peripheral gap. A seal (19), which is shown in FIGS. 1, 2, 6 and 9 as well as 12, can be arranged in this gap. The seal (19) can fill the said gap and prevent the entrance of environmental influences, e.g., dust, welding particles, etc. This ensures the insulating action. The seal (19) may have a ring-like design, e.g., according to FIG. 9 and can be mounted onto the insulating disk (13) on the circumference according to FIG. 6. The seal (19) has an opening (20), which is adapted to the outer contour of the insulating disk (13), in particular to its circumferential contour (14), which is possibly present and is not rotationally symmetrical. The outer circumferential shape of the seal (19) can be adapted to the shape of the respective electrode holder (5, 6) or its element holder (21, 22) in order to seal flush on the outside and to avoid the formation of a gap. The seal (19) consists of an electrically insulating and possibly elastic material. The seal material can possibly be compressed in the gap during the mounting and be pinched for sealing purposes.

FIGS. 1, 6, 10, 11 and 12 also illustrate the design of the movable electrode holder (5). This is arranged at the end of the guiding means (11) on the driven side and is located, e.g., at the end of its drive element (29). The electrode holder (5) may also have a disk-shaped element holder (21) with a passage opening (25), through which a fixing element (17) can extend for fastening the electrode (2) to the element holder (21) or to the drive element (29). On one side, the element holder (21) has the above-described receiver or socket (23). It may have an interface (33) for connection with the drive element (29) on the other side. This interface is formed, e.g., by rotationally engaged receivers (51), e.g., in the form of plug-in sockets at the lower end of the drive rod and on the top side of the element holder (21).

According to FIG. 12, the passage opening (25) has an enlarged cross section in the socket area and receives the tapered drive rod end, whereby the element holder (21) and the drive element (29) are supported on one another in the axial direction due to the graduated shape. Further, the drive rod end has a hole with an internal thread for fastening the fixing element (17). The fixing element (17) traverses the tool (2), in particular the electrode.

FIGS. 3 and 12 show further details of the feeding device (9) and its guiding means (11). On the top side, the guiding means (11) has an interface (32) for connecting with the replaceable drive (10) and, on the bottom side, the mentioned interface (33) to the tool holder (5). Further, on the rear side, it can have an interface for connecting with the support (8), which is designed as an attaching flange (39) here in the manner mentioned. The interfaces (32, 33, 39) make possible defined ports and adaptations to different supports (8), drives (10) and tool holders (5).

As FIGS. 3 and 12 illustrate, the guiding means (11) has a frame or a basic body (28), in which the drive element (29) is adjustably mounted and guided by means of a mount (30). The interface (32) has ports (34, 46) on the basic body (28) of the guiding means (11) and on the basic body or frame (47) of the respective drive (10), which are coordinated with one another and are used for the mutual exact positioning in a positive-locking manner and possibly fastening of the drive (10) to the guiding means (11).

Furthermore, the interface (32) has a port (35) at the drive element (29) and a port (38) at the driven element (37) of the drive (10), which can provide for their direct or indirect connection. The port (35) is designed, e.g., as a hole with internal thread at the upper end of the drive element (29). The port (38) can have a counterthread for a direct connection or can comprise an inserted coupling (36) or an adapter.

In the embodiment of FIG. 4, the pneumatic or hydraulic drive (40) has at the end of its piston rod (41) a connecting element, which is designed, e.g., as a ring groove, on which the coupling (36) acts with a fork or claw in a positive-locking manner for the transmission of axial forces and in turn is connected with the port (35) at the drive element (29).

In the variant of FIG. 5 of the servo drive (42) with the spindle nut (44), the latter can have on the jacket the port (38), e.g., in the form of an external thread, and be connected in a manner adapted to rotate in unison with the port (35) of the drive element (29), e.g., it can be rigidly screwed into the internal thread (35) thereof. The motor-driven threaded spindle (45) then pushes the spindle nut (44) and the drive element (29) back and forth in the axial direction (48) in a controllable and possibly regulatable manner. The threaded spindle (45) can project possibly into the central cavity of the drive rod (29) in a collision-free manner. The spindle drive can have, e.g., a low automatic locking and a recirculating ball bearing guide.

According to FIGS. 3 and 12, the drive element (29) designed, in the manner mentioned, as just a cylindrical drive rod, which performs an axial movement in the direction of the process axis (48) and is guided and supported in sliding or rolling bearings (30). The drive element (29) is uniformly designed for all drives (10) and drive forces.

In the embodiment shown, the means for securing against rotation (31) consists of rollers arranged in pairs, which mesh in a supporting and rolling manner with a guide rod spaced at a distance from and parallel to the axis (48) as well as fixed to the basic body (28). The rollers are in turn fastened to the drive rod (29) by means of sleeves or the like and are carried in their axial feed movements, whereby they roll off on the guide rod and prevent a rotation of the drive rod.

A sensor mechanism (49), which, e.g., absorbs the drive rod movements via the said rollers, can be arranged at the means for securing against rotation (31) as well according to FIG. 3. The sensor mechanism can be designed, e.g., as a displacement pickup, in particular as a potentiometer or the like. It can be connected with a control means (not shown) of the processing device (1) via the line shown in FIGS. 3 and 12. As an alternative, the sensor mechanism (49) can be omitted or can be arranged at a different location of the feeding device (9). It can be associated, e.g., with a drive (10), in particular a servo drive (42). As an alternative or in addition, a sensor mechanism can detect one or more other process parameters, e.g., a feeding or pressing force, a temperature, in particular a welding or soldering temperature, time or the like. The joining process, in particular the electrical resistance welding or soldering process, can be controlled or regulated, e.g., via the essential process parameters time, displacement and force and the detection thereof. The pressure-resistant insulating disk (13) is also advantageous for this because of its dimensional stability.

The possibly common cover (26) can be fastened to the guiding means (11). This guiding means can have, for this purpose, on its basic body (28) a corresponding bracket (50), which is formed, e.g., from wall recesses on both sides for the positive-locking receiving of the associated side walls of the cover (26). A fixing can take place by means of screws or the like. The cover (26) can, furthermore, be multipart with single fixing on the guiding means (11) and on the drive (10).

Further details of the adjusting device (12) are shown in FIGS. 13 through 15.

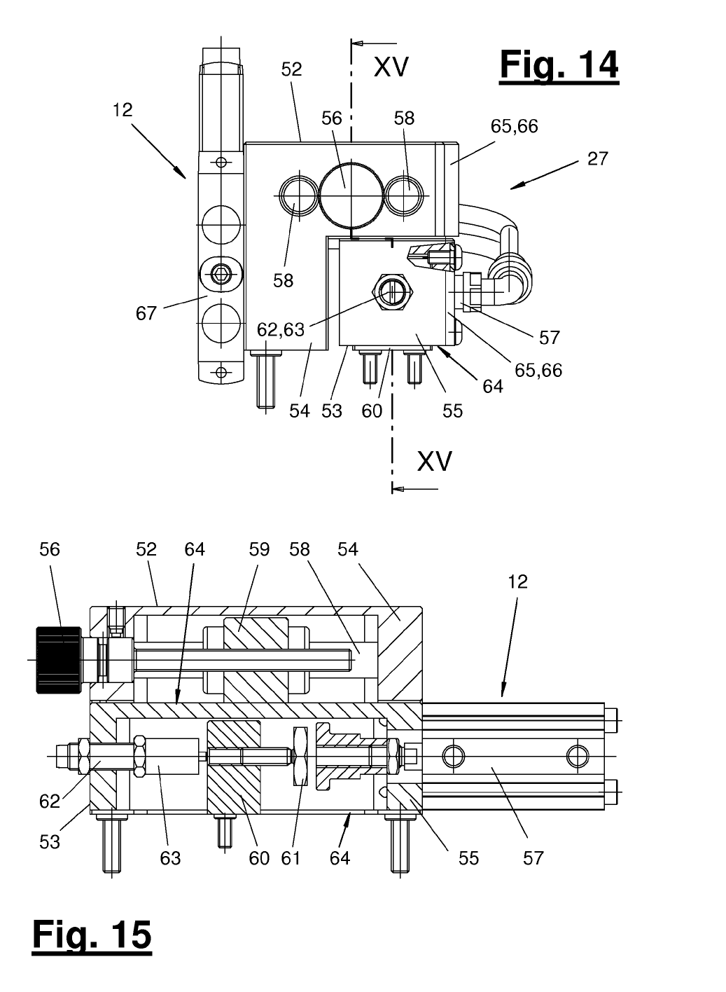

FIG. 13 shows the adjusting device (12) between the frame (7) and the support (8) without the feeding device (9) in a perspective view. FIG. 4 shows the related front view according to arrow XIV of FIG. 13, and FIG. 15 illustrates the section XV-XV of FIG. 14.

The adjusting device (12) is supported on the frame (7) and acts on a laterally projecting carrier (60) at the support (8). Hereby, the adjusting device (12) can position and possibly at least partly hold in this position the support (8) in the manner mentioned. In this case, the adjusting device (12) can be controlled depending on the function of the feeding device (9). In particular, it can be detached upon activation of the feeding device (9). For this, the adjusting device (12) and feeding device (9) can be coupled in a technically controlled manner or be connected with the processing device (1) with a common control means (not shown).

In the embodiment shown, the adjusting device (12) has a multipart design and has two adjusting parts (52, 53) with housings (54, 55) and actuating drives (56, 57). In variation hereto, the adjusting device (12) may have only one adjusting part (53) for interacting with the carrier (60), which can be supported directly on the frame (7) for this purpose. In another variant, the number of adjusting parts (52, 53) and their components may be greater.

The adjusting device (12) shown has a telescopic design, whereby the one adjusting part (52) is fixed on the frame (7) with the screws or other fastening elements shown in FIGS. 14 and 15 and supported here. The other adjusting part (53) is adjustably mounted on an adjusting part (52) by means of a guide (58). The adjusting axes of both adjusting parts (52, 53) are aligned parallel to one another and to the process axis (48).

In the embodiment shown, the adjusting part (53) is used for fine adjustment or for the mentioned positioning of the support (8) for the feeding of a workpiece between the opened tools (2, 3) or electrodes. The adjusting part (52) can be used for coarse adjustment or for increased feeding. The increased feeding path can be used for adaptation of different feeding devices (9) or to different tool or electrode configurations. As an alternative, the adjusting part (52) can be omitted.

The adjusting part (53) for the fine adjustment or positioning has a controllable actuating drive (57), which is designed, e.g., as a pneumatic cylinder with a control unit (67), in particular a valve unit. The actuating drive (57) acts with a driven element on the carrier (60), which is fastened to the support (8) with screws or the like. The actuating drive (57) may have a pure feeding function and push against a fixed or adjustable stop (52), which is arranged at the opposite end of the housing (55), when activating the carrier (60). A shock absorber (63) can be arranged upstream of the stop (62). The adjustable stop (62) may determine a defined support position for the tool feeding. The actuating drive (57) may, if necessary, be connected without power and may allow a return motion of the carrier (60) as well as of the support (8). This happens, e.g., when activating the feeding device (9) and makes possible the floating of the feeding device (9) and the tools (2, 3) or electrodes at the workpiece.

The actuating drive (57) can apply a predetermined force for carrying the support (8) and the carrier (60) as well as for overcoming the shock absorber (63). As an alternative, the actuating drive (57) can also execute a predetermined displacement with a given force and hereby position the carrier (60) besides the support (8). For this purpose, it can be designed in any suitable manner.

The housing (55) of the adjusting part (53) has an opening directed towards the support (8), through which the carrier (60) can project into the housing interior. As FIG. 15 illustrates, the carrier (60) may be adjustable, whereby it has, e.g., an adjusting element (61), which is movable by means of a thread or the like, which interacts with the driven part of the actuating drive (57). The housing (55) may have a further opening (65), which is directed towards the common operating and service side (27) and can be closed with a removable cover (66). The components of the stop (62), carrier (60) and actuating drive (57) located in the housing interior are accessible via this opening (65).

The adjusting part (53) is mounted in a longitudinally adjustable manner on the adjusting part (62) fixed to the frame in the manner mentioned and has a projecting attachment (59), which projects through an opening (64) into the hollow interior of the housing (54) of the adjusting part (52). The attachment (59) is connected there with the guide (58), which consists, e.g., of two parallel guide rods, which also form the mount for the adjusting part (53). The housing (54) may otherwise also have an opening (65) on the operating and service side (27) with a cover (66).

The adjusting part (52) may have a manual or mechanical actuating drive (56), which can also be adjusted or possibly controlled. In the embodiment shown, the actuating drive (56) is designed as an adjusting screw, which acts on the attachment (59) via a counterthread and with which the adjusting part (53) can be positioned in relation to the adjusting part (52). The position may, if necessary, be fixed, e.g., by means of the locking screw shown in FIG. 15. FIGS. 1, 2 and 13 show, moreover, another scale with indicator on the frame (7) and support (8) for determining the position.

Variants of the exemplary embodiments shown and described are possible in various ways. The above-described exemplary embodiments for one or more electrodes (2, 3) and electrode holders (5, 6) also apply correspondingly to other electrical processing devices (1) and their one or more tools and tool holders. A processing device (1) may have, for example, only one tool or one electrode (2), whereby the other pole of the power supply is connected at the workpiece. Furthermore, the tools or electrodes (2, 3) opposite one another at the workpiece can each have a feeding device (9). The number and shape of the tools or electrodes (2, 3) may deviate from the exemplary embodiments shown, whereby the number may, in particular, be greater than two.

Furthermore, variants are possible with regard to the structural design of the feeding device (9) and its components. The drive (10) may be designed, e.g., as a hydraulic cylinder, as a crank assembly or the like. In particular, a servo drive (42) may have a different output drive, e.g., a rack-and-pinion drive with a gear rack as a driven rod (45). A modified spindle drive may have a reverse kinematics with rotatingly driven spindle nut and pushed-out threaded spindle. Further, any other drive designs are possible.

In case of the guiding means (11) the drive element (29) may be designed, mounted and guided in different ways, e.g., as a connecting rod mechanism, in particular a shear gear mechanism, with correspondingly different arrangement and design of a drive. Further, the means for securing against rotation (31) may be omitted or be designed in different ways, e.g., by means of a cross-sectional shape of a drive rod that is not rotationally symmetrical.

In the embodiment shown, the feeding device (9) performs only axial feeding movements and return movements along the central process axis (48). As an alternative, it may perform one or more other and possibly superimposed movements, e.g., an oscillating or rotating peripheral movement, about the axis (48). A correspondingly different drive or possibly even a further drive can be present for this.

The above-described embodiments of the processing device (1) with its modular design, especially the modular design of the feeding device (9) with the guiding means (11) and the replaceable drives (10), have independent inventive importance and can also be designed and used without the claimed insulating disk (13) or with a different electrical insulating element, e.g., an insulating coating, an insulating film or the like. The design and arrangement of the feeding device (9) on a movable support (8) also have such an independent inventive importance. They may be achieved without the claimed insulating disk (13) or with a different electrical insulating element, e.g., an insulating coating, an insulating film or the like and are also independent of a modular or non-modular design of the possibly not changeable drive (10) and the guiding means (11).

While specific embodiments of the invention have been shown and described in detail to illustrate the application of the principles of the invention, it will be understood that the invention may be embodied otherwise without departing from such principles.

1. An electrical welding or soldering device, comprising:
an electrode tool, to which electric current and pressing pressure are applied;
an electrode tool holder, transmitting the pressing pressure; and
an electrical insulating element between the tool holder and the tool, the electrical insulating element comprising a pressure-resistant and dimensionally stable insulating disk made of a ceramic material.

2. An electrical processing device in accordance with claim 1, wherein the insulating disk has a contour capable of transmitting force and the contour is not rotationally symmetrical.

3-4. (canceled)

5. An electrical processing device in accordance with claim 1, wherein the insulating disk has planar top and bottom sides.

6. An electrical processing device in accordance with claim 1, wherein the insulating disk has a profiled contour on at least one of a top side and bottom side.

7. An electrical processing device in accordance with claim 1, further comprising a fixing element wherein:
the insulating disk has a passage opening for the fixing element; and
the fixing element has a shaft with a diameter which is smaller than the diameter of the passage opening and connects the tool holder and the tool in an electrically insulating manner.

8. (canceled)

9. An electrical processing device in accordance with claim 1, wherein the ceramic material is designed as oxide ceramic comprising one or more of aluminum oxide, zirconium oxide, titanium oxide and zirconium-reinforced aluminum oxide.

10. An electrical processing device in accordance with claim 1, further comprising a seal wherein:
the insulating disk is surrounded by the seal on a circumference thereof; and
the seal is arranged in a gap between the tool holder and the tool.

11. An electrical processing device in accordance with claim 2, wherein:
the tool holder has a receiver for the insulating element; and
the tool has a receiver for the insulating element.

12-13. (canceled)

14. An electrical processing device in accordance with claim 11, wherein:
the insulating disk meshes with the receivers in a positive-locking and preferably backlash-free manner in the mounting position; and
the receiver has a countercontour, which interacts with the contour of the insulating element in a positive-locking manner.

15-16. (canceled)

17. An electrical processing device in accordance with claim 11, wherein at least one of the receivers includes a recess that has a countercontour, which is complementary to the contour of the insulating element.

18. An electrical processing device in accordance with claim 17, wherein the at least one of the receivers has a depth that is smaller than the thickness of the insulating element.

19-21. (canceled)

22. An electrical processing device in accordance with claim 7, wherein the fixing element traverses the insulating element in the mounting position and is supported on the tool holder or on the tool with an insulating sleeve.

23. (canceled)

24. An electrical processing device in accordance with claim 1, wherein the electrode has a power connector that is insulated by the electrode holder and is arranged separately.

25. An electrical processing device in accordance with claim 1, further comprising a feeding device for the electrode tool.

26-33. (canceled)

34. An electrical insulating element for an electrical welding or soldering device, comprising an electrode tool, to which electric current and pressing pressure are applied and an electrode tool holder the electrical insulating element comprising a pressure-resistant and dimensionally stable insulating disk made of a ceramic material for installation between the tool and the tool holder.

35. An electrical insulating element in accordance with claim 34, wherein:
the insulating disk has a contour capable of transmitting force; and
the contour is not rotationally symmetrical.

36. (canceled)

37. An electrical insulating element in accordance with claim 34 wherein the insulating disk has a contour that is not rotationally symmetrical with flat surfaces on the circumference.

38. An electrical insulating element in accordance with claim 34 wherein the insulating disk has planar top and bottom sides.

39. An electrical insulating element in accordance with claim 34, wherein the insulating disk has a profiled contour on the top side andor bottom side.

40. An electrical insulating element in accordance with claim 34, wherein the insulating disk has a central passage opening for a fixing element.
